(19) United States
(12) Patent Application Publication
(10) Pub. No.: US 2018/0107972 A1
(43) Pub. Date: Apr. 19, 2018

(54) WIRELESS TRANSCEIVER-BASED TRACKING

(71) Applicant: Wal-Mart Stores, Inc., Bentonville, AR (US)

(72) Inventors: Nicholaus A. Jones, Fayetteville, AR (US); Matthew A. Jones, Bentonville, AR (US)

(21) Appl. No.: 15/785,640

(22) Filed: Oct. 17, 2017

Related U.S. Application Data
(60) Provisional application No. 62/409,218, filed on Oct. 17, 2016.

(51) Int. Cl. G06Q 10/08

(52) U.S. Cl. CPC G06Q 10/087

(57) ABSTRACT

An apparatus comprises a container (such as a retail shopping facility), a wireless transceiver, and a control circuit that utilizes the wireless transceiver to conduct a wireless communication with a product that is disposed within the container via a native wireless-communications capability of the product. The control circuit then maintains an inventory record of products as a function, at least in part, of the wireless communications with the product. The wireless communication can be initiated by the aforementioned control circuit or by the product as desired. Maintaining the inventory record can include adding the communicating product to the inventory record of products or confirming that the communicating product is already presently included in the inventory record of products.

### CROSS-REFERENCE TO RELATED APPLICATION

This application claims the benefit of U.S. Provisional Application No. 62/409,218, filed Oct. 17, 2016, and is incorporated herein by reference in its entirety.

### TECHNICAL FIELD

These teachings relate generally to wireless transceivers and more particularly to item tracking.

### BACKGROUND

In a modern retail store environment, there is a need to improve the customer experience and/or convenience for the customer. With increasing competition from non-traditional shopping mechanisms, such as online shopping provided by e-commerce merchants and alternative store formats, it can be important for “bricks and mortar” retailers to focus on improving the overall customer experience and/or convenience.

Accurate and timely inventory records regarding the available unsold contents of a given retail shopping facility are both important and notoriously difficult to maintain. Errors regarding the availability of products can lead to wasted associate attention and effort as well as disappointed customers.

### BRIEF DESCRIPTION OF THE DRAWINGS

The above needs are at least partially met through provision of the wireless transceiver-based tracking approaches described in the following detailed description, particularly when studied in conjunction with the drawings, wherein:

FIG. 1 comprises a block diagram as configured in accordance with various embodiments of these teachings;

FIG. 2 comprises a block diagram as configured in accordance with various embodiments of these teachings;

FIG. 3 comprises a flow diagram as configured in accordance with various embodiments of these teachings; and

FIG. 4 comprises a signal flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments an apparatus can comprise a container (such as a retail shopping facility), a wireless transceiver, and a control circuit that utilizes the wireless transceiver to conduct a wireless communication with a product that is disposed within the container via a native wireless-communications capability (such as a Wi-Fi or Bluetooth wireless communications capability) of the product. The control circuit can then maintain an inventory record of products as a function, at least in part, of the wireless communications with the product.

The aforementioned wireless communication can be initiated by the aforementioned control circuit or by the product as desired. These teachings will accommodate various approaches to maintaining the inventory record including by adding the communicating product to the inventory record of products or by confirming that the communicating product is already presently included in the inventory record of products.

So configured, the aforementioned control circuit can serve as a post-manufacturer supply-chain control circuit that communicates with unsold retail products having the aforementioned native communications capability to maintain more accurate inventory records regarding the availability of such products within, for example, a retail shopping facility.

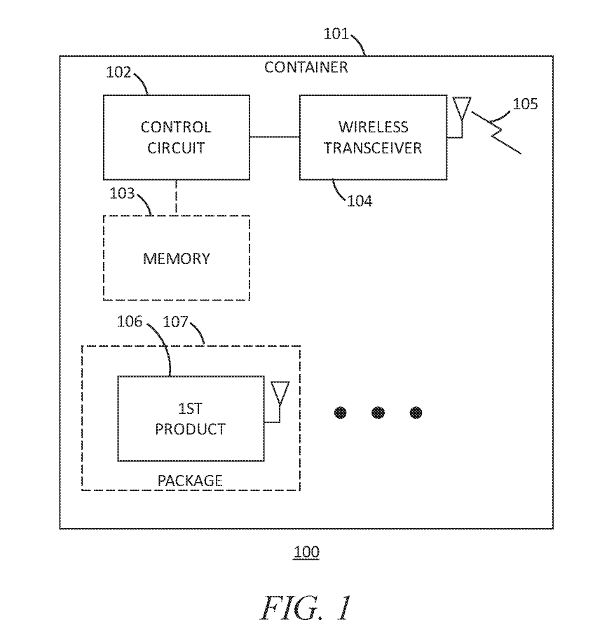

These and other benefits may become clearer upon making a thorough review and study of the following detailed description. Referring now to the drawings, FIG. 1 presents an example of an apparatus 100 that corresponds to the present teachings.

In this example the apparatus 100 includes a container 101. By one approach the container 101 comprises a retail shopping facility. A “retail shopping facility” comprises a retail sales facility or any other type of bricks-and-mortar (i.e., physical) facility in which products are physically displayed and offered for sale to customers who physically visit the facility. The shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility may be any size or format of facility, and may include products from one or more merchants. For example, a facility may be a single store operated by one merchant or may be a collection of stores covering multiple merchants such as a mall.

These teachings are highly flexible in practice and will accommodate other approaches in these regards. The container 101 may alternatively comprise, for example, a railcar, truck trailer, or other shipping container of choice.

In this particular example, the enabling apparatus 100 includes a control circuit 102 that may or may not be physically disposed within the aforementioned container 101 as appropriate to the needs of the application setting. Being a “circuit,” the control circuit 102 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 102 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 102 is configured (for example, by using corresponding programming as will be well understood by those skilled in the art) to carry out one or more of the steps, actions, and/or functions described herein.

By one optional approach the control circuit 102 operably couples to a memory 103. This memory 103 may be integral to the control circuit 102 or can be physically discrete (in whole or in part) from the control circuit 102 as desired. This memory 103 can also be local with respect to the control circuit 102 (where, for example, both share a common circuit board, chassis, power supply, and/or housing) or can be partially or wholly remote with respect to the control circuit 102 (where, for example, the memory 103 is physically located in another facility, metropolitan area, or even country as compared to the control circuit 102).

In addition to inventory information that is described herein, this memory 103 can serve, for example, to non-transitorily store the computer instructions that, when executed by the control circuit 102, cause the control circuit 102 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

If desired the control circuit 102 can also optionally couple to a network interface (not shown). So configured the control circuit 102 can communicate with other elements (both within the apparatus 100 and external thereto) via the network interface. Network interfaces, including both wireless and non-wireless platforms, are well understood in the art and require no particular elaboration here.

By another optional approach (in lieu of the foregoing or in combination therewith) the control circuit 102 can operably couple to a user interface (not shown). This user interface can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user. As one specific example in these regards the user can employ the user interface to query an inventory database and receive corresponding search results.

The example of FIG. 1 also includes a wireless transceiver 104 that operably couples to the control circuit 102. By one approach the wireless transceiver 104 comprises a Wi-Fi-compatible transceiver. Wi-Fi refers to a technology that allows electronic devices to connect to a wireless Local Area Network (LAN) (generally using the 2.4 gigahertz and 5 gigahertz radio bands. More particularly, “Wi-Fi” refers to any Wireless Local Area Network (WLAN) product based on interoperability consistent with the Institute of Electrical and Electronics Engineers' (IEEE) 802.11 standards.

By another approach, in lieu of the foregoing or in combination therewith, the wireless transceiver 104 comprises a Bluetooth-compatible transceiver. Bluetooth refers to a wireless communications standard managed by the Bluetooth Special Interest Group. The Bluetooth standard makes use of frequency-hopping spread spectrum techniques and typically provides for only a very short range wireless connection (typically offering a range of only about ten meters in many common application settings). This standard comprises a packet-based approach that relies upon a so-called master-slave paradigm where a master device can support only a limited (plural) number of subservient devices.

So configured, the control circuit 102 can utilize the wireless transceiver 104 to conduct wireless communications 105 as described herein.

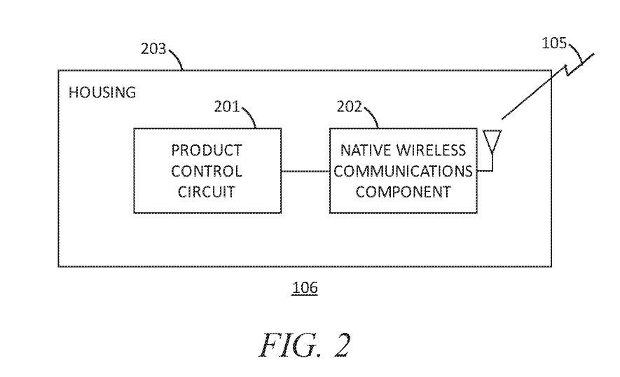

The aforementioned container 101 also has at least one product 106 disposed therein. For the sake of this description, and referring momentarily to FIG. 2, this product 106 includes a product control circuit 201 that operably couples to a native wireless communications component 202, both of which are disposed within a corresponding product housing 203. The product control circuit 201 may be architected similar to the above-described control circuit 102 (though configured to carry out the functionality as per the dictates and nature of the product itself).

The native wireless communications component 202 is configured to wirelessly communicate 105 with the above-described wireless transceiver 104. That said, the primary purpose of the wireless communications component 202 is not to communicate with the above-described wireless transceiver 104 but rather to conduct other wireless communications in support of other product functionality. Accordingly, and as an example, the native wireless communications component 202 may comprise a Wi-Fi transceiver such that the product control circuit 201 can utilize that Wi-Fi capability in support of ordinary product functionality. In that case, however, and presuming that the above-described wireless transceiver 104 also has Wi-Fi capability, these two elements 104 and 202 can also compatibly communicate with one another. (As used herein, the adjective “native” will be understood to indicate that the wireless communications component 202 constitutes original structural and functional content of the product 106 as designed and built by the manufacturer of the product 106 and serves a primary purpose of enabling the product control circuit 201 to wirelessly communicate with a variety of other devices other than the above-described control circuit 102.)

It will therefore be understood that the product 106 will not likely comprise such things as fresh produce, articles of clothing, health and beauty products, and so forth. Examples of products having the aforementioned architecture include so-called smart phones, pad/tablet-styled computers, laptop computers, digital cameras, computer displays, and televisions, to note but a few examples in these regards.

Referring again to FIG. 1, these teachings anticipate that the products 106 disposed within the container 101 comprise unsold retail products and are so located in order to make those products 106 available for purchase by a corresponding consumer. Accordingly, in many instances some or all of these products 106 are themselves contained within corresponding packaging 107. Examples include paperboard boxes. In a typical application setting, however, the aforementioned native wireless communications component 202 is, as described, a native part of the product 106 itself and is not attached to or otherwise a part of any applicable packaging 107. For example, the native wireless communications component 202 is not a radio-frequency identification (RFID) tag that is attached to or embedded within the packaging material.

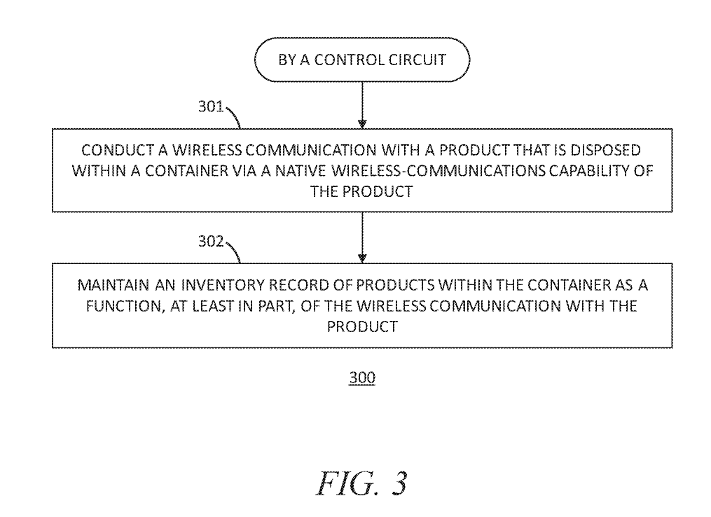

The above-described control circuit 102 can comprise a post-manufacturer and supply-chain control circuit that communicates with the above-described products 106 prior to possession of the latter by an end user (such as a purchasing customer). In particular, the above-described control circuit 102 can carry out the process 300 presented in FIG. 3.

In particular, at block 301 the control circuit 102 uses the aforementioned wireless transceiver 104 to conduct the wireless communication 105 with the product 106 while the product 106 is within the container 101 via the native wireless-communications capability of the product 106. These teachings are flexible in these regards and will accommodate, for example, the control circuit 102 initiating that wireless communication 105 (for example, pursuant to a previously-defined temporal schedule) or the product 106 initiating the wireless communication 105.

That wireless communication 105 can include, for example, identifying information for the product 106. This identifying information can be categorical in nature (and therefore serves to identify the product 106 as belonging to particular category of product as represented, for example, by a stock-keeping unit (SKU) number and/or model number) and/or product-specific in nature (such as a serial number or other unique product-specific identifier).

At block 302, the control circuit 102 then maintains an inventory record of products within the container 101 (as stored, for example, in the aforementioned memory 103) as a function, at least in part, of that wireless communication 105 with the product 106. For example, when the wireless communication 105 includes both a SKU number and a serial number, the control circuit 102 can update that inventory record by adding this particular product 106 to the record of in-container presently-available products. As another example, the control circuit 102 might utilize that same information to confirm that this particular product is presently already included in that inventory record of products.

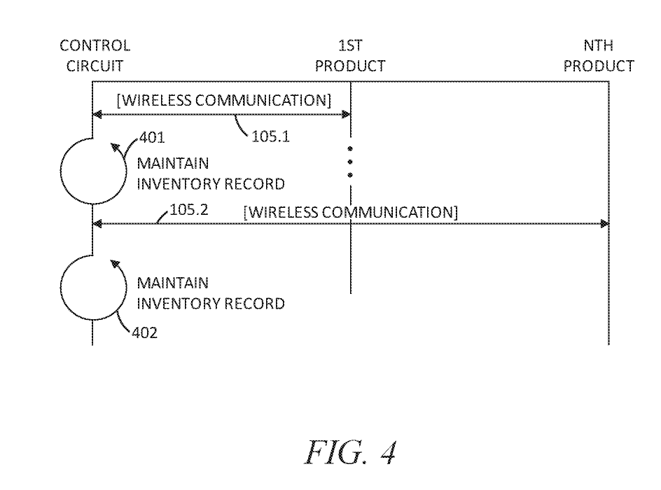

As noted above, there can be more than one such product 106 within the container 101 at any given time. These teachings will readily accommodate the control circuit 102 communicating with each such product as part of maintaining the corresponding inventory record of products. FIG. 4 provides a simple example in these regards where the control circuit 102 conducts a first wireless communication 105.1 with a first product and then maintains the inventory record as a function thereof as denoted by reference numeral 401. The control circuit 102 then conducts an Nth wireless communication 105.2 with an additional product (denoted here as an Nth product, where “N” is an integer greater than 1) and again maintains that inventory record to reflect that additional information as denoted by reference numeral 402.

So configured, these teachings serve to greatly leverage an already-available communications capability of certain products to better ensure inventory records regarding such products. Because these teachings rely upon the native communications capability of such products, these benefits are attained at relatively low incremental cost.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a container;
a wireless transceiver;
a control circuit operably coupled to the wireless transceiver and configured to:
use the wireless transceiver to conduct a wireless communication with a product that is disposed within the container via a native wireless-communications capability of the product; and
maintain an inventory record of products within the container as a function, at least in part, of the wireless communication with the product.

2. The apparatus of claim 1 wherein the container comprises a retail shopping facility.

3. The apparatus of claim 1 wherein the wireless transceiver uses Wi-Fi to conduct the wireless communication.

4. The apparatus of claim 1 wherein the wireless transceiver uses Bluetooth to conduct the wireless communication.

5. The apparatus of claim 1 wherein the product comprises an unsold retail product.

6. The apparatus of claim 1 wherein the wireless communication comprises a communication initiated by the product.

7. The apparatus of claim 1 wherein the wireless communication comprises a communication initiated by the control circuit.

8. The apparatus of claim 1 wherein the control circuit is configured to maintain the inventory record of products within the container by at least one of:
adding the product to the inventory record of products;
confirming that the product is presently already included in the inventory record of products.

9. A method comprising:
by a control circuit operably coupled to the wireless transceiver:
using the wireless transceiver to conduct a wireless communication with a product that is disposed within a container via a native wireless-communications capability of the product; and
maintaining an inventory record of products within the container as a function, at least in part, of the wireless communication with the product.

10. The method of claim 9 wherein the container comprises a retail shopping facility.

11. The method of claim 9 wherein using the wireless transceiver to conduct the wireless communication with the product comprises using the wireless transceiver to conduct a Wi-Fi wireless communication with the product.

12. The method of claim 9 wherein using the wireless transceiver to conduct the wireless communication with the product comprises using the wireless transceiver to conduct a Bluetooth wireless communication with the product.

13. The method of claim 9 wherein the product comprises an unsold retail product.

14. The method of claim 9 wherein the wireless communication comprises a communication initiated by the product.

15. The method of claim 9 wherein the wireless communication comprises a communication initiated by the control circuit.

16. The method of claim 9 wherein maintaining the inventory record of products within the container comprises maintaining the inventory record of products within the container by at least one of:
adding the product to the inventory record of products;
confirming that the product is presently already included in the inventory record of products.

17. An apparatus configured for use by an end user, the apparatus comprising:
a housing;
a native wireless communications component disposed within the housing;
a control circuit disposed within the housing and configured to use the native wireless communications component to automatically wirelessly communicate with a post-manufacturer supply-chain control circuit prior to possession by the end user.

18. The apparatus of claim 17 wherein the native wireless communications component comprises at least one of:
a Wi-Fi wireless communications component; and
a Bluetooth wireless communications component.

19. The apparatus of claim 17 wherein the control circuit is configured to automatically wirelessly communicate with the post-manufacturer supply-chain control circuit as a function of a unilaterally-initiated wireless communication with the post-manufacturer supply-chain control circuit.

20. The apparatus of claim 17 wherein the apparatus comprises one of:
a smartphone;
a pad/tablet-styled computer;
a laptop computer;
a digital camera;
a display.
